(19) United States
(12) Patent Application Publication
(10) Pub. No.: US 2008/0145649 A1
(43) Pub. Date: Jun. 19, 2008

(54) PROTECTIVE COATINGS WHICH PROVIDE WEAR RESISTANCE AND LOW FRICTION CHARACTERISTICS, AND RELATED ARTICLES AND METHODS

(75) Inventors: Uma Devi Mannem, Karnataka (IN); Krishnamurthy Anand, Bangalore (IN); Dennis Michael Gray, Delanson, NY (US); Farshad Ghasripoor, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC, Schenectady, NY (US)

(21) Appl. No.: 11/610,826

(22) Filed: Dec. 14, 2006

(51) Int. Cl. B32B 18/00; B05D 1/36; C04B 35/58; C04B 35/515

(52) U.S. Cl. 428/336; 508/150; 508/125; 508/126; 508/151; 508/137; 508/139; 428/450; 428/457

(57) ABSTRACT

A coating composition is described, containing (a) a metallic matrix based on nickel, cobalt, iron; or combinations thereof; (b) a ceramic phase, containing at least one metal boride or metal silicide compound; and (c) a lubricant phase. Methods of providing wear-resistance and low-friction characteristics to an article (e.g., a gas turbine) are also described, using the coating composition. Related structures are also discussed.

### BACKGROUND OF THE INVENTION

This invention generally relates to coatings for metal articles. In some specific embodiments, the invention relates to protective coatings which provide wear resistance and low-friction characteristics to metal articles which are exposed to high temperatures. Examples of such articles include turbomachines, such as turbine engines.

Metal components are used in a wide variety of industrial applications, under a diverse set of operating conditions. In many cases, the components are provided with coatings which impart various characteristics, such as corrosion resistance, heat resistance, oxidation resistance, and wear resistance. As one example, the various components of turbine engines are often coated with thermal barrier coatings, to effectively increase the temperature at which they can operate. Other examples of articles which require some sort of protective coating include pistons used in internal combustion engines and other types of machines.

Wear-resistant coatings (often referred to as “wear coatings”) are frequently used on turbine engine components, such as nozzle wear pads and dovetail interlocks. The coatings provide protection in areas where components may rub against each other, since the rubbing—especially high frequency rubbing—can damage the part. A specific type of wear is referred to as “fretting”. Fretting can often result from very small movements or vibrations at the juncture between mating components, e.g., in the compressor and/or fan section of gas turbine engines. For example, fretting can occur in regions where fan or compressor blades are joined to a rotor or rotating disc. This type of wear can necessitate premature repair or replacement of one or more of the affected components. Various alloys, such as those based on nickel or cobalt, are susceptible to fretting and other modes of wear. Many titanium alloys have especially poor anti-fretting characteristics.

Moreover, the need for good anti-fretting characteristics alone is sometimes not sufficient. Often, other characteristics for the coating—similar but distinct—are also required. These include anti-scuffing properties (e.g., in the case of piston rings and cylinder liners), as well as anti-friction properties.

A variety of coating systems have been used to impart wear resistance to metal substrates. Examples include those based on chromium; chromium carbide; cobalt-molybdenum-chromium-silicon, or copper-nickel-indium. The coatings can be applied by a variety of techniques, such as plating or thermal spraying. Examples of the latter technique include air plasma spray (APS), high velocity oxy-fuel (HVOF), and vacuum plasma spray (VPS).

Coatings formed by conventional chrome-plating have been used successfully for a number of years. The coatings can have varying thicknesses, and can be modified in a number of ways. As an example, particle-reinforced hard chromium layers have been applied to piston ring surfaces, to impart the required level of abrasion resistance. The coatings have also been very useful in a variety of aerospace applications.

While hard chromium coatings have been of great use in various applications, they also exhibit some drawbacks. For example, the integrity of these coatings is being challenged more often by the higher temperatures and pressures to which they are often subjected, in both aerospace and automotive engine applications. Furthermore, chrome plating can be a very time-consuming process.

Moreover, the toxicity of some of the chromate compounds is another drawback to the plating processes. In particular, hexavalent chromium is considered to be a carcinogen. When compositions containing (or releasing) this form of chromium are used, special handling procedures have to be very closely followed, in order to satisfy health and safety regulations. The special handling procedures can often result in increased costs and decreased productivity.

In many applications, chrome-plating processes have been replaced by spraying techniques, such as the thermal spray methods mentioned above. As an illustration, thermal spray techniques have been employed to deposit coatings based on tungsten carbide (WC), or chromium carbide (Cr₃C₂). While the resulting coatings are suitable for many purposes, they have limitations as well, e.g., in terms of thermal properties. Moreover, while the sprayed coatings may exhibit the required level of wear resistance, they may not have adequate low-friction properties.

Thermally sprayed cermet coatings have also become fairly popular for providing wear resistance in certain situations. Examples of these coatings include tungsten carbide-cobalt (WC—Co), tungsten carbide-cobalt-chromium (WC—Co—Cr), and chromium carbide/nickel chromium (Cr₃C₂—NiCr). As another example, U.S. Pat. No. 6,887,585 (Herbst-Dederichs) describes wear-resistant coatings based on a metallic phase, such as nickel or iron alloys, along with a ceramic phase, such as alumina, chromic oxide (Cr₂O₃), or titanium carbide (TiC). The coatings may also include a solid lubricant material to reduce friction. Examples of the lubricants include materials such as graphite, hexagonal boron nitride, and polytetrafluoroethylene.

While many of the cermet coatings are suitable for certain end uses, they also exhibit deficiencies. For example, the hardness of the WC- and Cr₃C₂-based coatings may be insufficient for other end uses, as mentioned above. Moreover, WC—Co coatings are usually restricted to temperatures below about 500° C., in oxidizing environments. The restriction is most prevalent in a thermal spray process such as HVOF or APS, and is due in part to carbide degradation. (Carbide degradation can occur when a WC material is oxidized, and forms brittle sub-carbides). Coatings like those based on Cr₃C₂—NiCr may have satisfactory wear properties at higher temperatures, e.g., about 500-900° C. However, it can be difficult to control the microstructure of such coatings during thermal spraying.

With all of these considerations in mind, it should be apparent that new wear-resistant coating compositions for metal substrates would be welcome in the art. The coatings should provide the necessary amount of wear-resistance (e.g., anti-fretting capabilities) desired for high temperature applications, while also providing good low-friction properties. The coatings should also meet the required standards for various other properties, such as hardness, corrosion resistance, heat resistance, and oxidation resistance. Moreover, the coatings should be capable of application by a variety of thermal spray processes.

### SUMMARY OF THE INVENTION

A coating composition is disclosed, comprising:
(a) a metallic matrix which comprises at least one metal selected from the group consisting of nickel, cobalt, iron, and combinations thereof;
(b) a ceramic phase, comprising at least one metal boride or metal silicide compound; and
(c) a lubricant phase.

A method of providing wear-resistance and low-friction characteristics to a metal article is also described herein. The method comprises the step of depositing a coating over at least one surface of the article, wherein the coating comprises the combination of components (a), (b), and (c), as described above.

Another embodiment of the invention is directed to an article which includes at least one surface on which a protective coating is disposed. The coating comprises the components set forth above, and further discussed in the remainder of the specification.

### DETAILED DESCRIPTION OF THE INVENTION

As mentioned above, one primary component of the present invention is a metallic matrix, which in part functions as a binder for the ceramic hard particles and the solid lubricant (discussed below) in the coating composition. Choice of the constituents for a particular matrix will depend on a variety of factors. One factor relates to the type of ceramic particles employed, and the ability of the matrix metals to adequately “wet” those particles. Another factor involves performance parameters for particular end uses for the coating, e.g., in terms of characteristics such as corrosion resistance, heat resistance, oxidation resistance, and wear resistance. Another factor relates to the potential interaction of matrix metals with the other constituents, e.g., the potential formation of undesirable compounds or phases at elevated temperatures.

Usually, the metallic matrix is based on at least one of nickel and cobalt. In some preferred embodiments, nickel is the most preferred constituent for the metallic matrix. As further described below, combinations of nickel and chromium are also preferred in some embodiments.

The metallic matrix very often includes a variety of other elements, depending on many of the factors discussed previously. Non-limiting examples are refractory elements such as tantalum, niobium, tungsten, zirconium, hafnium, and, molybdenum; as well as titanium, chromium, silicon, boron, calcium, cerium, iron, and vanadium. Many combinations of these elements may also be employed, and the selection of any element or combination thereof will depend on many of the criteria noted above. As an example, niobium can be included to provide ductility and strength, while chromium, zirconium, silicon, calcium, and cerium may be added to enhance oxidation resistance. In some instances, boron and silicon are also added for melting point suppression, while chromium (mentioned above) and molybdenum are often added for corrosion resistance.

A non-limiting illustration of the amount of components in a coating composition (for some embodiments) can be provided. Thus, for certain compositions in which the coating comprises at least about 25% by weight nickel, typical ranges for other constituents (if present) may be as follows (based on total coating composition, in weight):

Ta: about 0.5% by weight to about 1.5% by weight;

Ti: about 0.5% by weight to about 2% by weight;

Nb: about 0.5% by weight to about 2% by weight;

W: about 1% by weight to about 10% by weight;

Cr: about 2% by weight to about 50% by weight;

Zr: about 0.5% by weight to about 1% by weight;

Hf: about 0.5% by weight to about 1% by weight;

Si: about 0.5% by weight to about 4.5% by weight;

B: about 0.5% by weight to about 3.5% by weight; and

Mo: about 0.5% by weight to about 18% by weight.

Al: about 0.5% by weight to about 20% by weight.

Y: about 0.5% by weight to about 1% by weight.

In some preferred embodiments, the matrix composition itself comprises nickel and chromium. For example, the matrix could include about 70% to about 90% nickel and about 5% to about 25% chromium, based on the total weight of the matrix, with the balance comprising one or more of the elements listed above. In other preferred embodiments, the matrix composition comprises nickel, chromium and molybdenum. In that instance, the matrix may sometimes include about 50% to about 80% nickel; about 5% to about 20% chromium, and about 10% to about 30% molybdenum, with the balance comprising the other elements described previously. Various other combinations of metals for the matrix are also preferred in some embodiments. Non-limiting examples include: cobalt and chromium; iron and chromium; iron and manganese; and iron with cobalt. Those skilled in the art will be able to select the most appropriate matrix composition for a particular situation, based in part on the teachings herein. Usually, the metallic matrix (component (a)) is present at a level in the range of about 5% by volume to about 70% by volume, based on the total volume of the coating. In some specific embodiments, the metallic matrix is present at a level in the range of about 15% by volume to about 35% by volume.

As mentioned above, the coating composition also includes at least one ceramic phase (i.e., a “primary ceramic phase”), which can provide the required amount of wear resistance and load-bearing characteristics for a given application. (As used herein, the term “ceramic” may include a variety of hard-phase materials, e.g, metal oxides, including those which are prepared commercially, as well as those which occur naturally). The ceramic phase can be formed from one or more constituents. Examples include various boride and diboride compounds, chromium disilicide, and the like. These and other ceramic constituents which may sometimes be suitable are described in U.S. Pat. No. 6,887,585 (Herbst-Dederichs) and U.S. Pat. No. 4,681,817 (Shinada), both incorporated herein by reference. The selection of particular ceramic components will depend in part on the factors described previously. For example, coating compositions which will protect turbine parts subjected to a high degree of fretting usually must include ceramic components which provide a relatively high degree of abrasion resistance and wear resistance. The ceramic particles usually (but not always) have an average particle size in the range of about 0.2 micron to about 5 microns.

Boride-containing ceramic compounds are preferred in some instances. As a non-limiting example, the ceramic phase sometimes comprises at least about 50% by weight boride compounds, and preferably at least about 80% boride compounds. General examples of the compounds include the transition metal diborides. (As used herein, “boride” is meant to embrace both borides and diborides, unless otherwise specified).

Some of the preferred compounds of this type are Group VI compounds such as tungsten diboride (tungsten diboride), chromium boride, and molybdenum boride, as well as the refractory borides of Group IV (Ti, Zr, and Hf) and Group V (V, Nb, and Ta). It appears that these refractory borides exhibit a wide homogeneity range for boron, which permits greater boron proportions than those typically calculated by way of stoichiometry. The higher, relative boron content can in turn provide greater hardness and bond strength for the overall coating composition. Moreover, the Group IV and Group V borides also appear to exhibit a layered crystal structure, i.e., layers of metal atoms alternating with layers of boron atoms. The layered structure may be beneficial in some instances because of its affinity to certain solid lubricants (discussed below) which also exhibit a layered crystal structure. In some especially preferred embodiments, titanium diboride (titanium boride) is employed as at least one of the ceramic constituents.

In some optional, specific embodiments, the coating composition further comprises a secondary ceramic phase. The secondary phase can function to increase the overall toughness of the composition. The phase usually comprises at least one material selected from the group consisting of silicon carbide, various metal carbides (e.g., boron carbide, titanium carbide, and tungsten carbide); various metal oxides (e.g., titanium dioxide and alumina); titanium nitride, diamond dust, and various nano-compounds, e.g., those having an average particle size of less than about 1 micron, and more often, about 10 to about 100 nanometers. Non-limiting examples of the nano-compounds are nano-alumina and other stable hard, oxide nano-particles formed from yttrium oxide, yttria-stabilized zirconia, hafnium oxide, silicon oxide (silicon dioxide), and mullite. Combinations of any of these materials are also possible. In some cases, preferred materials for the secondary phase are alumina, titanium nitride, diamond dust, and various combinations thereof. The secondary ceramic phase, if included, is usually present at a level which is no greater than about 30 volume % of the entire ceramic phase.

The particles which form the primary ceramic phase usually have an average particle size of at least 0.2 micron, and up to about 5 microns. In some specific embodiments, the particle size is in the range of about 0.2 micron to about 3 microns, and more specifically, in the range of about 1 micron to about 1.5 microns. Moreover, in some preferred embodiments, the secondary ceramic phase has a finer particle size (e.g., nanoscale, on average) than that of the primary phase. The average particle size for the secondary ceramic phase is usually less than about 1 micron, and more specifically, no greater than about 100 nanometers.

The amount of the ceramic phase(s) will vary considerably, depending on many of the factors described herein, including, for example, the particular type of ceramics being used, as well as the desired hardness for the coating composition. In general, the ceramic phase (total) is present at a level in the range of about 30% by volume to about 95% by volume, based on the volume of the entire coating composition. In some specific embodiments, the level is in the range of about 40% by volume to about 80% by volume. In some especially preferred embodiments, the level is in the range of about 50% by volume to about 70% by volume. The reduced, maximum amount in the last-mentioned range is sometimes advantageous for allowing the desired amount of lubricant component, discussed below.

As also noted previously, the coating composition includes a lubricant phase. The lubricant phase is formed of at least one material selected from the group consisting of hexagonal boron nitride, graphite, molybdenum disulfide, tungsten sulfide; cryolite, calcium difluoride; barium difluoride (also referred to as “calcium fluoride” and “barium fluoride”, respectively); mica, talc, calcium sulfate, and polytetrafluoroethylene. Combinations of any of these lubricants are also possible, e.g., eutectic mixtures of calcium difluoride and barium difluoride. Some exemplary lubricant materials, which are normally characterized by a very low friction coefficient, are described in the Herbst-Dederichs and Shinada patents referenced above. Some are also described in Taylor et al, U.S. Pat. No. 5,682,596, which is also incorporated herein by reference. Usually, the lubricant component is incorporated into the composition in solid, powdered form. The presence of the lubricant is very important for providing lubricity to the coating, to decrease the friction between two surfaces.

The particular lubricant selected will depend on various factors (many were discussed previously). Wear and friction considerations for the part(s) on which the coating is being applied are key considerations, as well as the operating temperature of the part. The exposure temperature for the coating is important, since many lubricants can break down at very high temperatures. Compatibility of the lubricant with the materials which are used for the metallic matrix and ceramic phase is also an important consideration—during thermal spray deposition, and during use of the part at operating temperatures. In some embodiments, the preferred lubricants are hexagonal boron nitride, graphite, tungsten sulfide; molybdenum disulfide; and combinations thereof. Hexagonal boron nitride is especially preferred in some cases.

The desired particle size of the lubricant will depend on the particular material being used. A particle size which is too small will decrease the beneficial effect of the lubricant, in reducing friction. Conversely, if the particle size of the lubricant is too large, tribological and mechanical properties may suffer. For example, the mechanical strength of the coating may decrease. Usually, the lubricant particles have a size which permits them to be situated within the spacing that separates the primary hard particles in the metallic binder. In most embodiments, the average particle size of the lubricants is no greater than about 2 microns, and preferably, less than about 1 micron. The minimum particle size is at least about 0.2 micron.

The amount of lubricant which is utilized will also depend on many of the factors mentioned previously. As an example, an excessive amount of lubricant (or lubricant particles which are too large) may decrease the mechanical strength of the coating. Usually, the lubricant phase is present at a level in the range of about 1% by volume to about 30% by volume of the coating composition. A typical range for lubricant content (total solid lubricant content) is about 5% by volume to about 15% by volume.

The coating compositions of the present invention may sometimes include additional constituents, e.g., those which function to lower the overall melting point. As mentioned previously, boron or silicon could be used (in elemental form, or in the form of alloys or other compounds). In some instances, these melting point suppressants can be incorporated in the form of a braze composition. Braze compositions are known in the art, and described, for example, in the Kirk-Othmer Encyclopedia of Chemical Technology, 3rd Edition, Vol. 21, pages 342 et seq. If the metallic matrix comprises primarily nickel, then the braze alloy usually contains at least about 40% by weight nickel. A cobalt-based metallic matrix can usually include either a cobalt-based braze alloy or a nickel-based braze alloy.

The braze alloy constituent, if employed, often contains silicon and/or boron, as noted previously. Examples of other types of braze alloys which may be suitable in certain circumstances include precious metal compositions containing silver, gold, and/or palladium, in combination with other metals, such as copper, manganese, nickel, chrome, silicon, and boron. Many of the metal braze compositions are available from Praxair Surface Technologies, Inc.

A number of methods may be used to prepare the coating compositions described herein, e.g., see the Herbst-Dederichs patent referenced above. Those familiar with conventional ceramic and metal powder processing techniques would be aware of proper procedures and processing details. Non-limiting examples of suitable techniques include mechanical milling or various other mechanical alloying processes; spray-drying; and self-propagating, high-temperature synthesis (SHS). Another suitable technique involves sintering of the raw material powders, followed by crushing of the resulting pellets. The preparation techniques can involve multiple steps, and/or combinations of various techniques. As one illustration, mechanical miling procedures can be used to prepare composite particles. Coating compositions which are based on these particles are characterized by a finely-distributed solid lubricant (or multiple lubricants) and ceramic phase (or multiple ceramic phases), which enhances the wear-resistance and lubricity of the coating. Those familiar with these techniques are also familiar with related procedures, e.g., classification steps (for the raw materials or final composite powders), to obtain the desired particle size range for thermal spraying.

A brief description of two of the other preparation methods can also be provided. Spray-drying is described in various references, such as U.S. Pat. No. 4,131,542 (Bergna et al) and U.S. Pat. No. 4,477,492 (Bergna et al), incorporated herein by reference. While many types of spray-drying techniques can be employed, most (though not all) generally include the following steps: atomization of a feed material into a spray; mixing and flow to produce spray-air contact; drying of the spray by moisture removal; and separation of the dried product from the air. The characteristics of the dried product are determined by the physical and chemical properties of the feed, and by the conditions used in each stage of the process.

SHS techniques are also described in various references. One example is “Abrasive Wear Behaviour of Ni(Cr)—TiB₂ Coatings Deposited by HVOF Spraying of SHS-Derived Cermet Powders”, B. Lott et al, Wear 254 (2003) 340-349, which is incorporated herein by reference. In general, SHS involves the ignition of mixed compacted reactant-powders, to produce an exothermic, self-sustaining reaction. As an example, the cermet-type powders described herein can be produced by mixing the desired elemental powders, which will react to form a hard ceramic phase (or phases), a relatively inert binder phase, and a solid lubricant phase (or phases).

An exemplary, non-limiting procedure can be described for SHS. Proportionate amounts of the constituent powders can initially be selected, to provide a target composition. The proportions are generally selected according to stoichiometric formation-calculations. However, some deviation from strict stoichiometry can be undertaken for various purposes, e.g., processing considerations (see the Lott et al reference). The powder constituents can be combined in any conventional dry-mixer. The mixed powder is then compacted into a thin-walled, cylindrical tube formed of various materials, such as graphite. (In some cases, the inside of the tube is lined with a material such as ceramic paper). The compacted tube is then placed in a reactor vessel, which is evacuated and back-filled with an inert gas such as argon, to atmospheric pressure.

The SHS reaction can then be initiated at the top of the powder compact, by electrical heating of a tungsten filament, in close proximity to the compact surface. Once initiated, the reaction proceeds down the cylindrical compact at a fairly rapid speed, e.g., 1-2 minutes for a tube which has a length of about 160 mm and a diameter of about 50 mm. After cooling to room temperature, the porous, reacted compact is removed from the container. The powder can then be comminuted and classified in a serious of conventional steps, to provide the desired particle size range. Those skilled in the art are familiar with many variations on this exemplary process.

The coating compositions described herein can be made by other techniques as well. As a non-limiting example, the compositions can be prepared by the techniques described in patent application Ser. No. ______ (Patent Docket 214063-1), which is filed simultaneously with the present application, and incorporated herein by reference. Patent application Ser. No. ______ (Patent Docket 214063-1) is being filed on behalf of Farshad Ghasripoor et al, and is assigned to the assignee of the present invention. According to some of the embodiments of the application of Ghasripoor et al, a mixture of solvent and solid lubricant particles could be infiltrated (e.g., with a vacuum) into porous particles formed of a ceramic or metallic material. The particles could then be heat-treated to evaporate the solvent. In the present instance, the lubricant/solvent material (or some portion thereof) could be infiltrated into powder particles comprising the metallic matrix, the ceramic phase, or some combination thereof. (Additional mixing/alloying could be used to incorporate any remaining material into the final product).

The coating composition can be applied to a substrate by a variety of different techniques, some of which were mentioned previously. Selection of a particular technique will depend on various factors, such as the type and composition of the coating powder, feedstock particle size, and the end use contemplated for the part. Spray techniques are often effectively used here. Non-limiting examples include plasma deposition (e.g., ion plasma deposition, vacuum plasma spraying (VPS), low pressure plasma spray (LPPS), and plasma-enhanced chemical-vapor deposition (PECVD)); HVOF techniques; high-velocity air-fuel (HVAF) techniques; PVD, electron beam physical vapor deposition (EBPVD), CVD, APS, cold spraying, and laser ablation.

Thermal spray techniques are of special interest for some embodiments. Examples listed above include VPS, LPPS, HVOF, HVAF, APS, and cold-spraying. In many instances, HVOF or HVAF is the preferred technique. Those skilled in the art are familiar with the operating details and considerations for each of these techniques. Moreover, various combinations of any of these deposition techniques could be employed. It should also be noted that in some preferred embodiments, thermally-sprayed coatings are ground and polished after being deposited. These steps provide a degree of surface roughness which enhances wear-resistance, and decreases friction characteristics. In some embodiments, the coatings are ground to a surface roughness less than about 8 micro-inches (Rₐ), prior to use, and more often, to a surface roughness less than about 4 micro-inches (Rₐ).

A variety of substrates could be covered or partially covered by the coating compositions described herein. Many of them are components for turbines, e.g., land-based turbines, marine turbines, and aeronautical turbines. Specific, non-limiting examples of the turbine components are buckets, nozzles, blades, rotors, vanes, stators, shrouds, combustors, and blisks. Non-turbine applications are also possible. Examples include components of other articles used under conditions of high temperature and/or high-wear environments. One such article is an internal combustion engine. As an example, the coating could be used on bearing surfaces and flanks of piston rings in such engines. (The substrate is usually formed of a metal material. As used herein, “metal” is meant to also include materials which are primarily formed of metal or metal alloys, but which may also include some non-metallic constituents, components or attachments, e.g., those made of ceramics, plastics, and the like).

As alluded to previously, the coatings described herein are particularly useful for deposition on a metal alloy which includes a contact surface which is shaped or positioned to cooperate with the contact surface of an abutting member. In such an instance, the coating (which could also be applied to the abutting member) substantially prevents fretting wear between the contact surfaces. It is believed that the coatings are especially suitable for supporting high-contact stresses between such surfaces, e.g., stresses which may exceed about 30,000 psi. Moreover, the coatings may be especially useful when employed under oxidizing conditions at elevated temperatures, e.g., above about 650° F. (343° C.). In contrast, prior art wear coatings, like those based on molybdenum sulfide and an organic binder, may oxidize and lose their effectiveness under such conditions.

The thickness of the coating will depend on many of the other factors discussed previously, e.g., composition of the coating and article, the end use of the article, and the like. Usually, the coating will have a thickness of about 50 microns to about 1,000 microns. In some specific embodiments (e.g., in many of the gas turbine applications), the thickness will be in the range of about 100 microns to about 200 microns.

It will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent articles, and other references mentioned above are incorporated herein by reference.

What is claimed:

1. A coating composition, comprising:
(a) a metallic matrix which comprises at least one metal selected from the group consisting of nickel, cobalt, iron; and combinations thereof;
(b) a ceramic phase, comprising at least one metal boride or metal silicide compound; and
(c) a lubricant phase.

2. The coating composition of claim 1, wherein the lubricant phase comprises at least one material selected from the group consisting of hexagonal boron nitride, graphite, molybdenum disulfide, tungsten sulfide; cryolite, calcium difluoride; barium difluoride, calcium-barium difluoride, mica, talc, calcium sulfate, polytetrafluoroethylene; and combinations of any of the foregoing.

3. The coating of claim 1, wherein the metallic matrix of component (a) is present at a level in the range of about 5% by volume to about 70% by volume, based on the total volume of the coating.

4. The coating of claim 1, wherein the ceramic phase of component (b) is present at a level in the range of about 30% by volume to about 95% by volume, based on the total volume of the coating.

5. The coating of claim 1, wherein the lubricant phase of component (c) is present at a level in the range of about 1% by volume to about 30% by volume, based on the total volume of the coating.

6. The coating of claim 1, wherein the metallic matrix comprises nickel and chromium.

7. The coating of claim 6, wherein the metallic matrix further comprises molybdenum.

8. The coating of claim 1, wherein the metallic matrix comprises at least about 50% by weight nickel, based on the total weight of the matrix.

9. The coating of claim 1, wherein the metallic matrix further comprises at least one metal selected from the group consisting of tantalum, titanium, niobium, tungsten, chromium, zirconium, hafnium, molybdenum, silicon, boron, titanium, chromium, calcium, cerium, and vanadium.

10. The coating of claim 1, wherein the ceramic phase comprises at least one boride which includes a Group IV, Group V, or Group VI element.

11. The coating of claim 10, wherein the ceramic phase comprises titanium diboride.

12. The coating of claim 1, wherein the ceramic phase comprises at least one compound selected from the group consisting of titanium diboride, zirconium diboride, tantalum boride, tungsten boride, and chromium disilicide.

13. The coating of claim 1, wherein the ceramic phase comprises ceramic particles having an average particle size in the range of about 0.2 micron to about 5 microns.

14. The coating of claim 1, further comprising a secondary ceramic phase.

15. The coating of claim 14, wherein the secondary ceramic phase comprises materials which increase the toughness of the coating.

16. The coating of claim 14, wherein the secondary ceramic phase comprises at least one material selected from the group consisting of alumina, titanium nitride, diamond dust, silicon carbide, metal carbides, titanium dioxide, and combinations thereof.

17. The coating of claim 14, wherein the secondary ceramic phase comprises ceramic particles having an average particle size less than about 1 micron.

18. The coating of claim 14, wherein the amount of the secondary ceramic phase is no greater than about 30 volume % of the entire ceramic phase.

19. The coating of claim 1, comprising component (b) as a primary ceramic phase, along with a secondary ceramic phase, wherein the particles which form the primary ceramic phase have an average particle size in the range of about 1 micron to about 3 microns; and the particles which form the secondary ceramic phase have an average particle size no greater than about 100 nanometers.

20. The coating of claim 1, wherein the lubricant phase comprises lubricant particles having an average particle size in the range of about 0.2 micron to about 2 microns.

21. The coating of claim 1, wherein the lubricant phase of component (c) comprises hexagonal boron nitride.

22. The coating of claim 1, further comprising at least one element or compound which functions as a melting point suppressant.

23. The coating of claim 22, wherein the element or compound which functions as a melting point suppressant comprises a braze alloy.

24. The coating of claim 23, wherein the braze alloy comprises boron, silicon, or a combination of boron and silicon.

25. A metal substrate at least partially coated with the composition of claim 1.

26. A turbomachine containing at least one surface covered by the composition of claim 1.

27. A wear-resistant, low-friction coating composition for protecting at least portions of a metal substrate, comprising:
(a) a metallic matrix, comprising chromium and at least about 50% by weight nickel, based on the total weight of the matrix;
(b) a ceramic phase, comprising at least one refractory boride which includes a Group IV or Group V element; and
(c) a lubricant phase, comprising at least one material selected from the group consisting of hexagonal boron nitride, graphite, molybdenum disulfide, tungsten sulfide; cryolite, calcium difluoride; barium difluoride, calcium-barium difluoride, polytetrafluoroethylene; mica; talc; calcium sulfate; and
combinations of any of the foregoing.

28. The coating composition of claim 27, wherein component (c) comprises at least one material selected from the group consisting of hexagonal boron nitride, graphite, tungsten sulfide; molybdenum disulfide, and combinations thereof.

29. The coating composition of claim 28, wherein
the metallic matrix of component (a) is present at a level in the range of about 5% by volume to about 70% by volume, based on the total volume of the coating;
the ceramic phase of component (b) is present at a level in the range of about 30% by volume to about 95% by volume, based on the total volume of the coating; and
the lubricant phase of component (c) is present at a level in the range of about 1% by volume to about 30% by volume, based on the total volume of the coating.

30. A method of providing wear-resistance and low-friction characteristics to a metal article, comprising the step of depositing a coating over at least one surface of the article, wherein the coating comprises:
(a) a metallic matrix which comprises at least one metal selected from the group consisting of nickel, cobalt, iron; and combinations thereof;
(b) a ceramic phase, comprising at least one metal boride or metal silicide compound; and
(c) a lubricant phase.

31. The method of claim 30, wherein the lubricant phase comprises at least one material selected from the group consisting of hexagonal boron nitride, graphite, molybdenum disulfide, tungsten sulfide; cryolite, calcium difluoride; barium difluoride, calcium-barium difluoride, polytetrafluoroethylene; mica; talc; calcium sulfate; and combinations of any of the foregoing.

32. The method of claim 30, wherein the metal article comprises a superalloy material based on nickel, cobalt, iron, or combinations thereof.

33. The method of claim 30, wherein the metal article is a turbine engine component.

34. The method of claim 30, wherein the surface of the article is a first contact surface shaped to cooperate with a second contact surface of an abutting member, and the coating applied to at least the first contact surface provides an interface with the second contact surface.

35. An article which includes at least one surface on which a protective coating is disposed, wherein the coating comprises:
(a) a metallic matrix which comprises at least one metal selected from the group consisting of nickel, cobalt, iron; and combinations thereof;
(b) a ceramic phase, comprising at least one metal boride or metal silicide compound; and
(c) a lubricant phase.

36. The article of claim 35, wherein the lubricant phase comprises at least one material selected from the group consisting of hexagonal boron nitride, graphite, molybdenum disulfide, tungsten sulfide; cryolite, calcium difluoride; barium difluoride, calcium-barium difluoride, polytetrafluoroethylene; mica; talc; calcium sulfate; and combinations of any of the foregoing.

37. A metal article according to claim 35.

38. The article of claim 35, in the form of a turbine engine component.

39. The article of claim 35, wherein the protective coating has a thickness in the range of about 50 microns to about 1,000 microns.
